(19) United States
(12) Patent Application Publication
(10) Pub. No.: US 2013/0217525 A1
(43) Pub. Date: Aug. 22, 2013

(54) BELT TENSIONING DEVICE WITH LOCATING PIN

(71) Applicants: Robert James Crist, Bentonville, AR (US); Kevin Gerard Dutil, Bentonville, AR (US); Anthony Eugene Lannutti, Fayetteville, AR (US); James Kevin Lindstrom, Springdale, AR (US); Jeffrey Allen Pendergrass, Everton, MO (US)

(72) Inventors: Robert James Crist, Bentonville, AR (US); Kevin Gerard Dutil, Bentonville, AR (US); Anthony Eugene Lannutti, Fayetteville, AR (US); James Kevin Lindstrom, Springdale, AR (US); Jeffrey Allen Pendergrass, Everton, MO (US)

(73) Assignee: DAYCO PRODUCTS, LLC, Tulsa, OK (US)

(21) Appl. No.: 13/399,552

(22) Filed: Feb. 17, 2012

(51) Int. Cl. F16H 7/12; B23P 11/00

(52) U.S. Cl. 474/111; 474/133; 474/135; 29/428

(57) ABSTRACT

A tensioning system including a body having a base and an engagement surface pivotally coupled to the base. The system further includes a biasing mechanism operatively coupled to the engagement surface to bias the engagement surface relative to the base, and a locating device coupled to the body. The locating device is configured to rotationally position the tensioning system, and the locating device has an adjustable effective length.

The present invention is directed to a belt tensioning device, and more particularly, to a belt tensioning device with a feature for angular and/or axial orientation of the belt tensioning device.

### BACKGROUND

Belt tensioners are utilized to ensure the associated belt, such as a belt in an automotive vehicle, is placed and maintained in the desired state of tension. During assembly of the vehicle, the tensioner may be mounted and activated in a series of steps. However, existing assembly methods and device may be insufficient to ensure that the tensioner is properly located.

### SUMMARY

In one embodiment, the present invention is a tensioning system including a body having a base and an engagement surface pivotally coupled to the base. The system further includes a biasing mechanism operatively coupled to the engagement surface to bias the engagement surface relative to the base, and a locating device coupled to the body. The locating device is configured to rotationally position the tensioning system, and the locating device has an adjustable effective length to span an axial gap during assembly.

### BRIEF DESCRIPTION OF DRAWINGS

FIG. 1 is a front view of a belt system utilizing a tensioner;

FIG. 2 is a side cross section of the tensioner of FIG. 1, taken along line 2-2, with the fastener fully threaded into place;

FIG. 3 illustrates the tensioner of FIG. 2, with the fastener only initially threaded into place;

FIG. 4 illustrates the tensioner of FIG. 3, with the tensioner moved against the head of the fastener;

FIG. 5 illustrates the tensioner of FIG. 4 with an alternate pin arrangement;

FIG. 6 illustrates the tensioner of FIG. 5, with the fastener tightened down;

FIG. 7 is a side view of an alternate pin arrangement, wherein the tensioner is only initially mounted;

FIG. 8 is a side view of the pin arrangement of FIG. 7, wherein the tensioner is fully mounted;

FIG. 9 is a side view of another alternate pin arrangement, wherein the tensioner is only initially mounted;

FIG. 10 is a side view of the pin arrangement of FIG. 9, wherein the tensioner is fully mounted;

FIG. 11 is a side view of another alternate pin arrangement, wherein the tensioner is only initially mounted;

FIG. 12 is a side view of the pin arrangement of FIG. 11, wherein the tensioner is fully mounted;

FIG. 13 is a side view of another alternate pin arrangement, wherein the tensioner is only initially mounted;

FIG. 14 is a side view of the pin arrangement of FIG. 13, wherein the tensioner is fully mounted;

FIG. 15 is a side view of another alternate pin arrangement, wherein the tensioner is only initially mounted;

FIG. 16 is a side view of the pin arrangement of FIG. 15, wherein the tensioner is fully mounted;

FIG. 17 is a side view of another alternate pin arrangement, wherein the tensioner is only initially mounted;

FIG. 18 is a side view of the pin arrangement of FIG. 17, wherein the tensioner is fully mounted;

FIG. 19 is a side view of another alternate pin arrangement, wherein the tensioner is only initially mounted;

FIG. 20 is a side view of the pin arrangement of FIG. 19, wherein the tensioner is fully mounted;

FIG. 21 is a side view of another alternate pin arrangement, wherein the tensioner spaced away from the anchor body;

FIG. 22 is a side view of another alternate pin arrangement, wherein the tensioner is only initially mounted; and

FIG. 23 is a side view of the pin arrangement of FIG. 22, wherein the tensioner is fully mounted.

### DETAILED DESCRIPTION

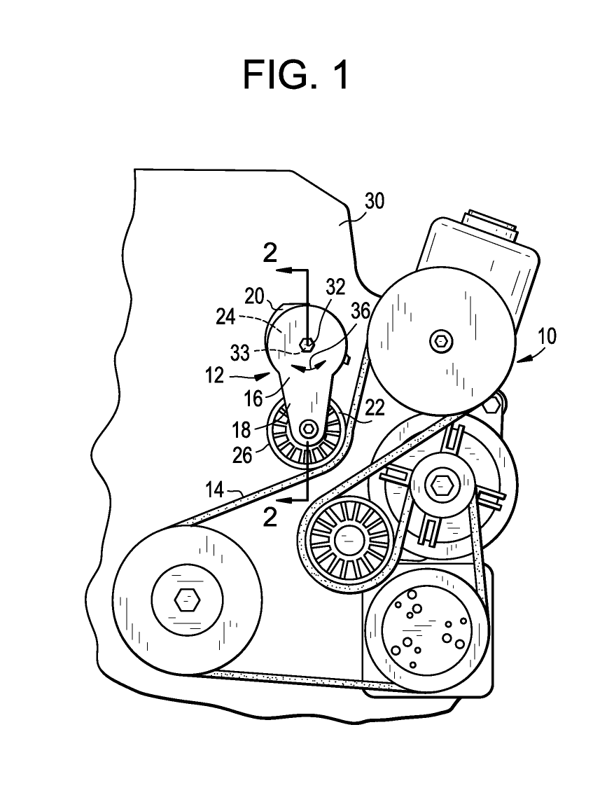

FIG. 1 is a front view of a belt system, generally designed 10, shown in association with a belt tensioner 12. The belt system 10 includes an endless power transmitting element 14, such as a belt, chain or the like, which passes around a variety of pulleys, gears, guides. The power transmitting element 14 thereby drives a plurality of driven accessories, and/or is driven by one or more of the components. The power transmitting element 14 can, in one case, take the form of a timing belt/chain, a drive belt/chain, a transmission belt/chain or the like for use in an automotive vehicle. After being configured with a proper wind-up, the tensioner 12 engages the power transmitting element 14 to apply the desired force to the power transmitting element 14 to induce the desired tension.

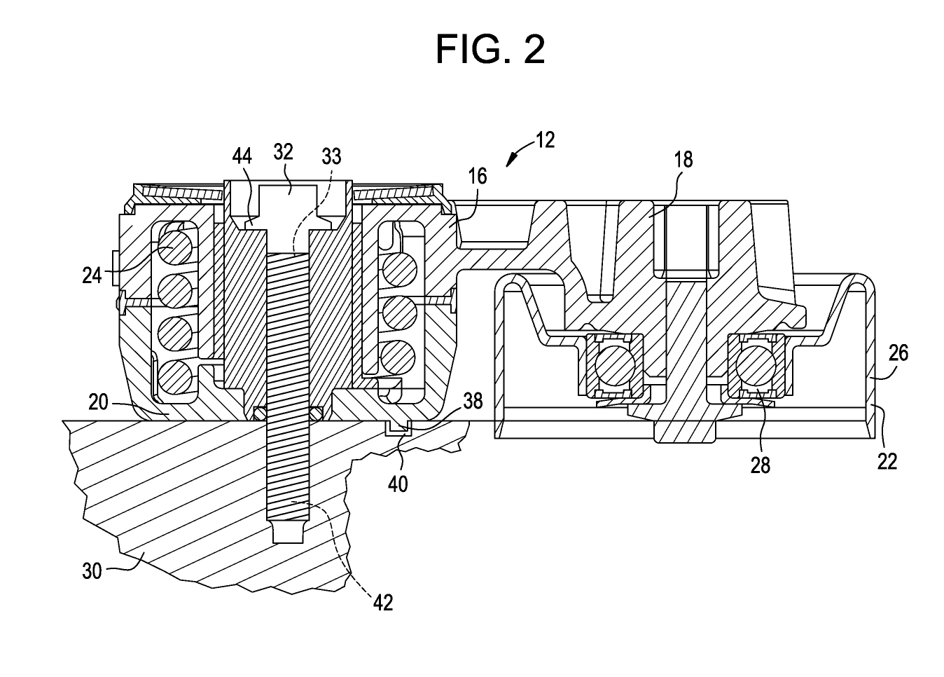

The tensioner 12 includes a body 16 having an arm 18 movably coupled to a base 20. The tensioner 12 further includes a belt engagement surface 22 positioned at one end of the arm 18, and a biasing mechanism 24 at the other end, in the particular illustrated embodiment. In one embodiment, the belt engagement surface 22 takes the form of a generally cylindrical roller 26 rotatably coupled to the arm 18 via a bearing 28, as shown in FIG. 2, such that the roller 26 can rotate as the belt 14 rolls past the tensioner 12. Alternately the belt engagement surface 22 can take the form of a smooth, but non-rotatable, component with high-lubricity.

The arm 18 is pivotally coupled to the base 20, and the base 20 is configured to be fixedly and non-rotatably coupled to an anchor body 30, such as an engine, engine block, engine cover, frame, etc. In one embodiment the tensioner 12/base 20 is coupled to the anchor body 30 by a threaded fastener 32, such as a bolt, extending through a central opening 33 of the tensioner 12 and into the anchor body 30. The bolt 32 thereby defines, or is aligned with, an axis about which the arm 18 is pivotable. In some embodiments, however, the bolt 32 may not be aligned with the axis about which the arm 18 pivots.

The biasing mechanism 24 can take the form of a spring (FIG. 2), such as a coil spring or torsion spring, or other biasing devices. The biasing mechanism 24 urges the arm 18/roller 26 into contact with the belt 14 with the desired amount of force, and causes the arm 18 to pivot about the axis (i.e. in the direction of the arrows 36 shown in FIG. 1) to accommodate varying forces applied to the arm 18/roller 26 by the belt 14. The biasing mechanism 24 helps control the desired force in the belt 14 so that the belt 14 is not too tight, which can place excess strain on the system 10, and is not too loose, which can cause rattling or whipping of the belt 14. The proper angular orientation of the tensioner 12 ensures that the proper force is applied to the belt 14 to induce the appropriate tension. The tensioner 12 can also include a damping mechanism to damp movement of the arm 18. Further details relating to one such tensioner 12 can be found in U.S. Pat. No. 6,575,860, the entire contents of which are incorporated herein.

With reference to FIG. 2, it can be seen that the tensioner 12, and in particular the base 20, includes a pin 38 extending downwardly therefrom, generally parallel to the pivot axis/fastener 32, and offset from the axis/fastener 32. The pin 38 may be generally cylindrical in one embodiment, but can have any of a wide variety of other shapes and configurations. The anchor body 30 includes a recess 40 which may be shaped to closely receive the pin 38 therein (i.e. the recess 40 may be cylindrical or other shapes to match the pin 38).

The pin 38 and recess 40 cooperate during the mounting/assembly of the tensioner 12 to the anchor body 30. In particular, in order to mount the tensioner 12 to the anchor body 30, the pin 38 is placed into the recess 40, and the central opening 33 of the tensioner is aligned with an opening 42 of the anchor body 30. The fastener 32 is then freely passed through the central opening 33 of tensioner 12 and threaded into the opening 42 of the anchor body 30.

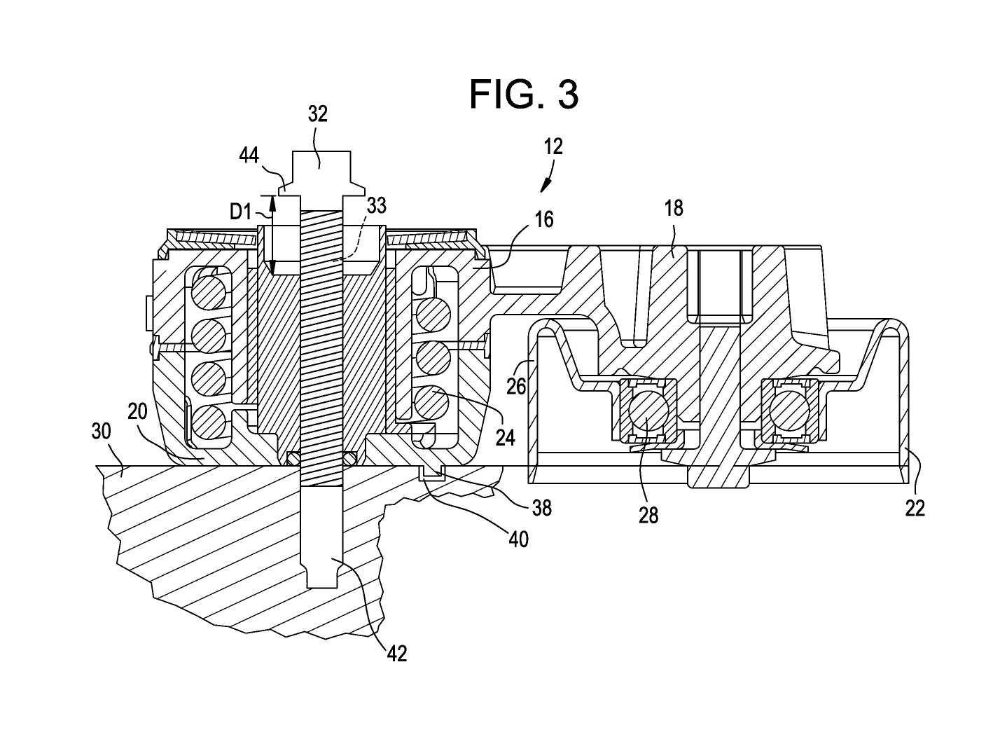

During typical assembly operations, the fastener 32 may initially be only partially threaded into the anchor body 30, as shown in FIG. 3. For example, during assembly the manufacturer may initially turn the fastener 32 a predetermined number of turns (i.e. 2.5 turns, in one case) to preliminarily secure the tensioner 12 in place. The anchor body 30 and tensioner 12 are then passed downstream (i.e. in an assembly line), or other operations may be carried out, before the fastener 32 is fully tightened down. At a later stage in manufacturing/assembly, the fastener 32 is fully tightened down such that its head 44 engages the tensioner 12, thereby locking the tensioner 12 in place, as shown in FIG. 2.

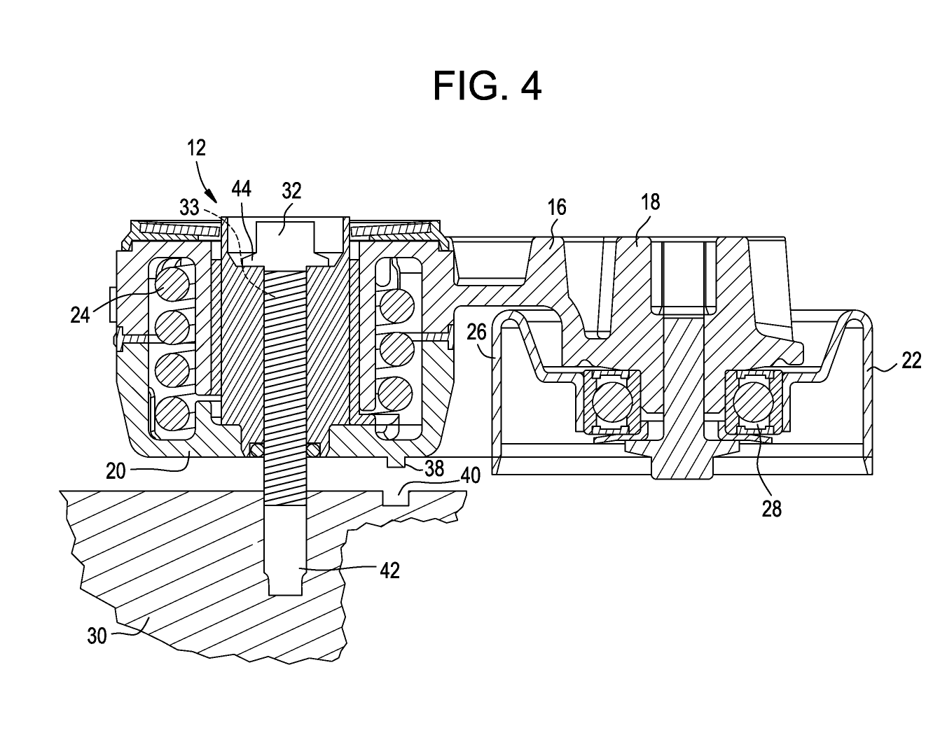

In certain cases, the tensioner 12 may be misaligned during initial assembly, or may be able to become misaligned after initial assembly and before final tightening. In particular, if the distance D1 (FIG. 3) between the top of the tensioner 12 and the bottom of the head 44 of the fastener 32 is greater than the depth/axial length of the pin 38, then it is possible that the tensioner 12 can move away from the anchor body 30 sufficiently to cause the pin 38 to be retracted out of the recess 40, as shown in FIG. 4. When the pin 38 is retracted out of the recess 40, the tensioner 12 is no longer rotationally locked in place and can spin about the fastener 32 (in some cases simply due to gravitational forces), which can causes a loss of rotational position. When the tensioner 12 is improperly rotationally positioned, the tensioner 12 can cause damage to other components, become fastened in an improper rotational position, require additional steps to secure the tensioner 12 in place, cause other issues with manufacturing/assembly, or fail to function properly.

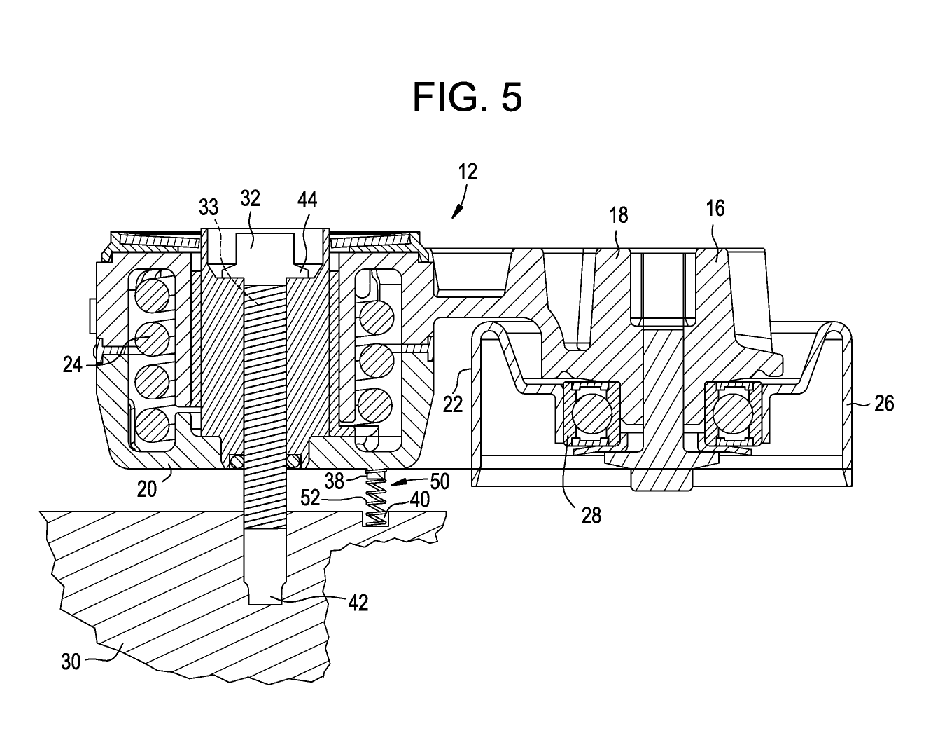

The depth of the recess 40 in the anchor body 33 may, in some cases, be limited such that the pin 38 cannot simply be lengthened in order to address this issue, and such a change may also expensive changes in tooling and could result in a pin 38 that is prone to breakage. Thus, in one case, in order to ensure that the tensioner 12 is rotationally locked in place after only initial/partial assembly of the fastener 32, the effective length of the pin 38 may be able to be increased without requiring a change in the depth of the recess 40. For example, FIG. 5 illustrates one particular embodiment of the pin 50 in which a spring 52 is coupled to the existing pin stub 38 such that the spring 52 and pin stub 38 together form or define a variable length locating device 50, or a pin 50 with a variable effective length.

The pin 50 may have a maximum effective length (i.e. its length in its uncompressed state) that is greater than the gap D1 (FIG. 3) between the bottom of the head 44 of the fastener 32 and the top of the tensioner 12 (i.e. the top surface of the arm 18/tensioner 12 where the head 44 of the fastener 32 engages the arm 18/tensioner 12) when the fastener 32 is initially threaded into the anchor body 30 (i.e. threaded sufficiently into place that the fastener 32 cannot be removed solely by applying an axial force to the fastener 32). In this case, as shown in FIG. 5, even when the tensioner 12 is positioned such that it is spaced as far away from the anchor body 30 as possible along the secured fastener 32, the pin 50 remains positioned in the recess 40, thereby maintaining proper rotational position of the tensioner 12. The pin 50 may also have a maximum effective length that is equal to or longer than the difference between the length of the fastener 32 and the length of the central opening 33.

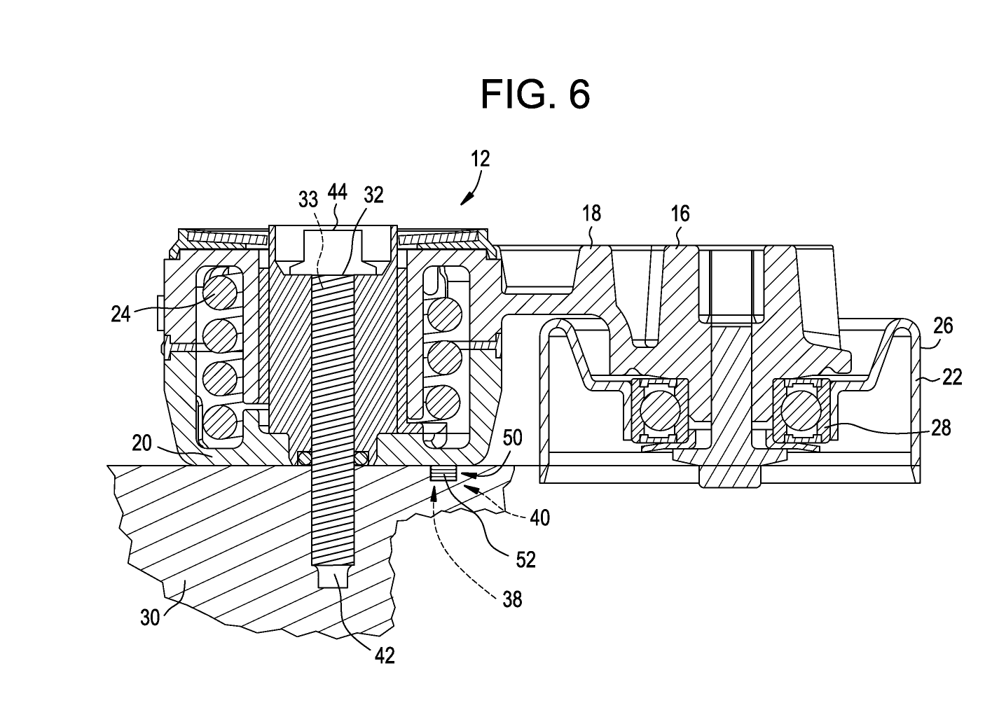

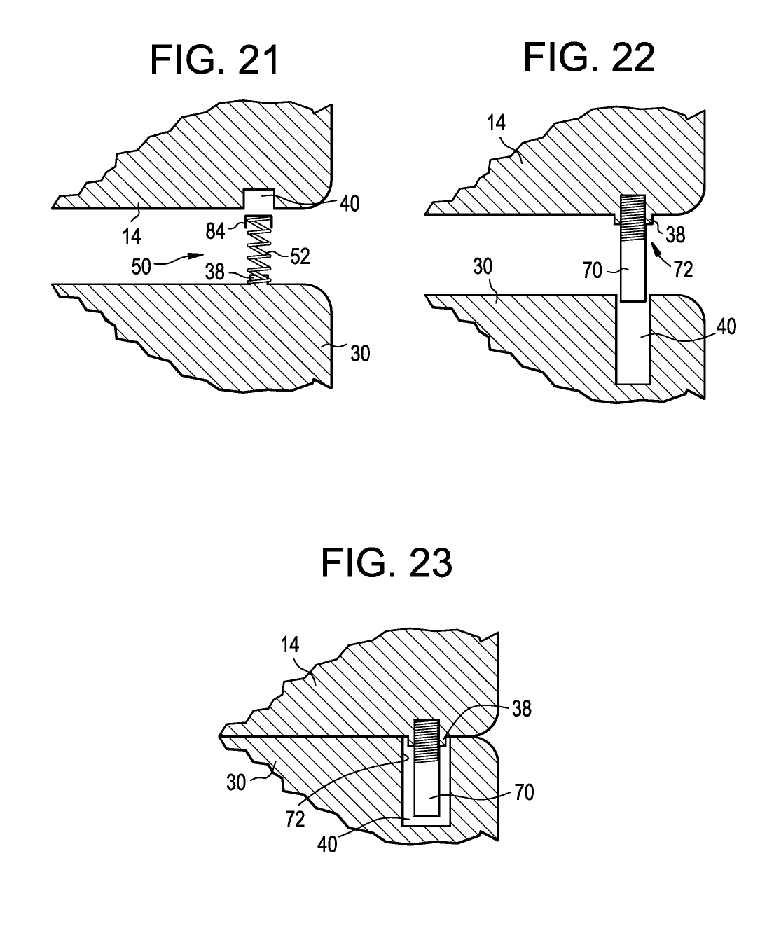

Thus, as can be seen, the pin 50 provides a greater effective length to ensure that the pin 50 remains positioned in the recess 40 across the full range of axial motion of the tensioner 12 along the axis/fastener 32. Once it is desired to fully couple the tensioner 12 in place, the fastener 32 is fully tightened down, as shown in FIG. 6. In this case, the spring 52 is axially compressed such that it is fully received in the recess 40. The forces required to install/fully tighten down the fastener 32 should be sufficient to compress the spring 52. The spring 52 may include a cap (e.g., see cap 84 in FIG. 21) at its free axial end to provide protection and durability to the spring 52. The spring 52 can take any of a variety of forms, such as a coil spring, a hollow cylindrical wave spring, etc.

In the embodiment shown in FIGS. 5 and 6 the spring 52 is coupled to the pin stub 38, as described above, to together form or define a variable length locating pin 50. This embodiment can be used to retro-fit existing tensioners 12 simply by coupling the spring 52 to the already-existing pin stub 38. In this case, however, it may be necessary to increase the diameter of the recess 40 to accommodate the additional diameter provided to the pin 50 by the spring 52. Alternately, rather than utilizing a pin stub 38, the entire pin 50 may take the form of a spring 52 directly coupled to the tensioner 12.

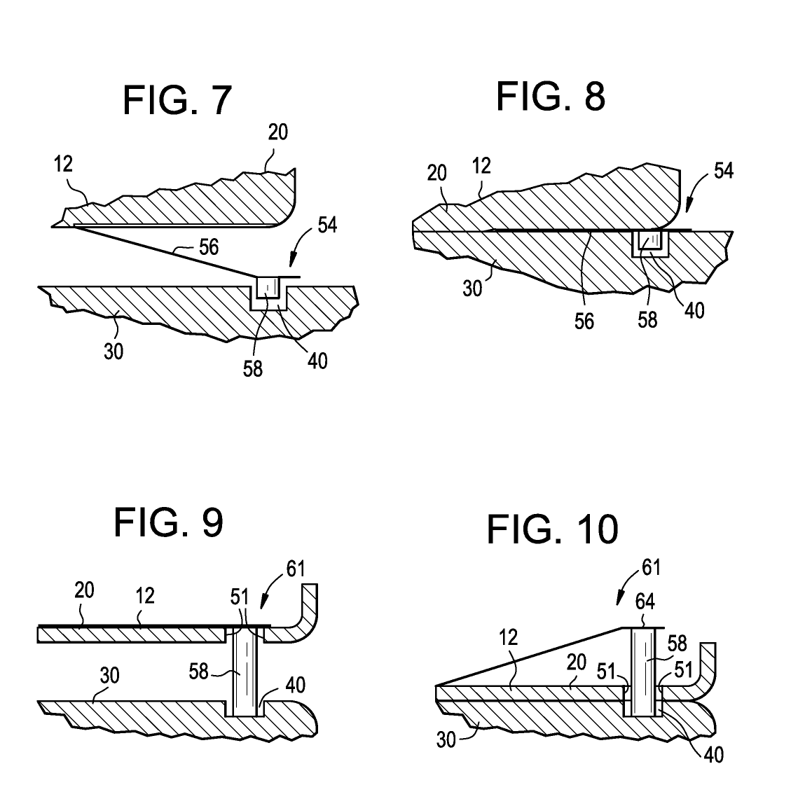

FIGS. 7 and 8 illustrate another embodiment in which the pin or locating device 54 includes, or takes the form or, a cantilever spring. In this case the cantilever spring includes a spring body 56, which can be made of a piece of spring metal or the like, extending generally radially and coupled to the tensioner 12. A pin stub 58 is coupled to the free end of the spring body 56, extends generally axially, and is configured to fit into the recess 40. As shown in FIG. 7, when the tensioner 12 spaced away from the anchor body 30, the spring body 56 extends at an angle relative to a radial plane and the pin stub 58 is positioned in the recess 40. As shown in FIG. 8, when the tensioner 12 is fully coupled to the anchor body 30, the spring body 56 is pressed generally flat into a radial plane, thereby reducing the effective length of the pin 54.

In the embodiment of FIGS. 7 and 8, the locating device 54 is positioned externally of the tensioner 12. In contrast, in the embodiment of FIGS. 9 and 10, the locating device 62 is positioned internally of the tensioner 12. In this case the spring body 56 is configured to be biased into its flat position, as shown in FIG. 9, in which case the pin stub 58 protrudes outwardly. When the tensioner 12 is positioned adjacent to the anchor body 30, the spring 56 is urged out-of-plane into its position shown in FIG. 10. This embodiment may be advantageous in that the side wall 51 of the anchor body 30 helps to provide support to the pin stub 58 when radial forces are applied thereto.

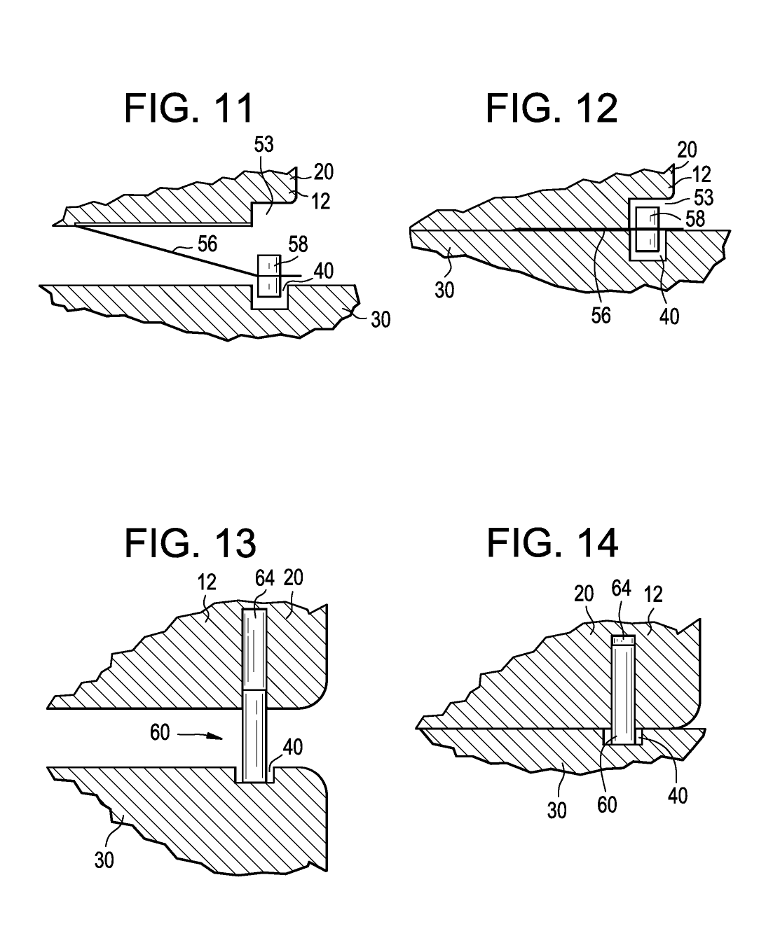

FIGS. 11 and 12 illustrate a further variant of the cantilever spring embodiment in which the pin stub 58 extends axially in both directions from the spring body 56 and is receivable in the recess 40, along with a recess 53 of the tensioner 12. In this case, then, the side wall of the recess 53 helps to support the pin stub 58 when radial forces are applied thereto. It is noted that the “exterior” cantilever spring embodiments of FIGS. 7-8 and 11-12 do not require significant interior space inside the tensioner 12.

FIGS. 13 and 14 illustrate another embodiment, like that of FIGS. 9 and 10, in which the actual length of the pin 60 remain the same, but its effective length is reduced by translation of the pin 60. In this embodiment the pin 60 is movably coupled to the tensioner 12 such that the pin 60 is translatable along its axis. FIG. 13 illustrates the pin 60 in its extended position. The pin 60 is held in placed by a frictional/interference fit with the associated opening 64. When the tensioner 12 is fully coupled to the anchor body 30, as shown in FIG. 14, the pin 60 is forced into the tensioner 12, received in the opening 64. In this illustrated embodiment the pin 60 remains in its refracted position, even after the anchor body 30 and tensioner 12 are subsequently separated. The embodiment of FIGS. 13 and 14 may provides ease of assembly in some cases, since the pin 60 is relatively easily refracted, and does not need to overcome a spring force.

In the embodiment of FIGS. 13 and 14, the tensioner 12 requires sufficient space to accommodate the internal opening 64. However, rather than being positioned in the main portion of the base 20, the opening 40 could instead be located in a component (i.e. a cylindrical lug or the like) positioned immediately adjacent to the main portion of the base 20.

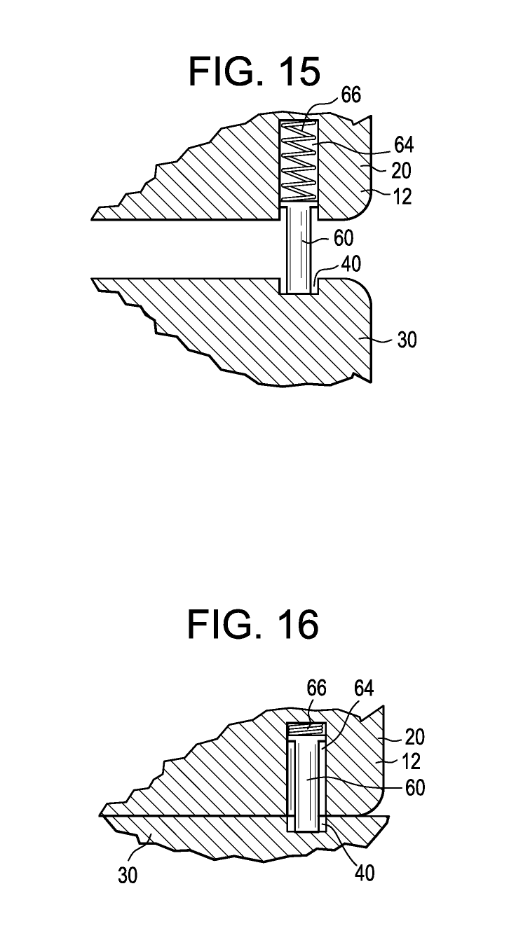

FIGS. 15 and 16 illustrate an alternate embodiment to that of FIGS. 13 and 14 in which a spring 66 is positioned in the opening 64. In this embodiment, the spring 66 urges the pin 60 to its extended position when the tensioner 12 is separated from the anchor body 30. This feature can be used to aid in subsequent re-mounting of the tensioner 12 to the anchor body 30 should the tensioner 12 need to be removed for repair or to enable access to other components. Various other spring loaded pins, such as locating pins, spring plungers, ball-and-detent, pistol springs, etc., with functionality similar to the embodiment shown in FIGS. 15 and 16, may be utilized.

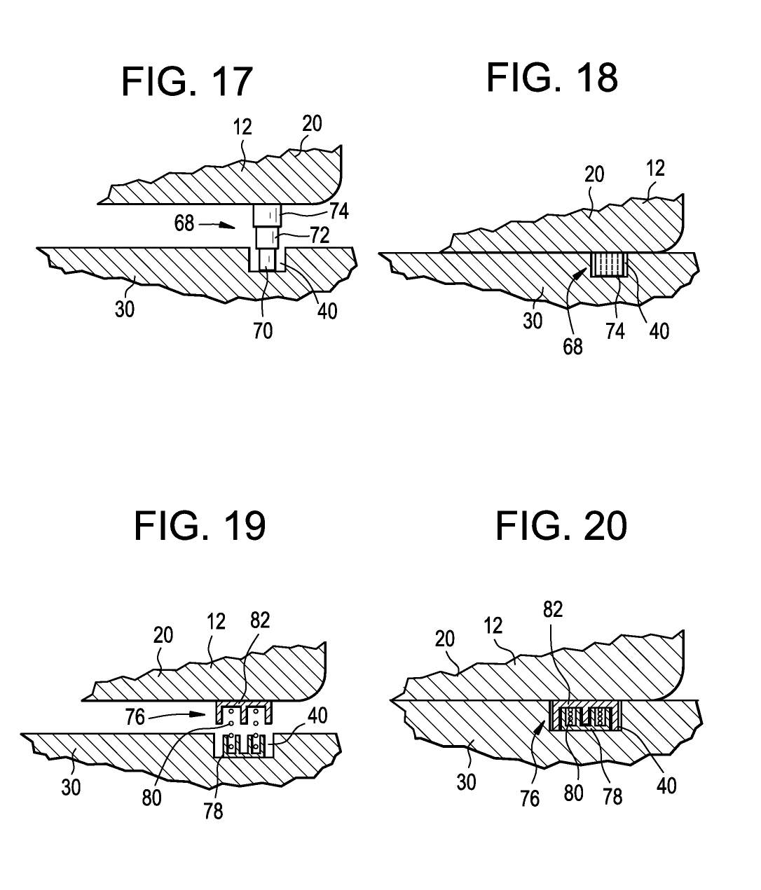

FIGS. 17 and 18 illustrate yet another embodiment in which the pin/locating device 68 has collapsible/nesting telescoping portions 70, 72, 74 such that the pin 68 can be moved between its extended position (FIG. 17) and its retracted position (FIG. 18). The embodiment shown in FIGS. 17 and 18 may be spring biased to its extended position, or may lack any spring biasing. The number of telescoping portions can vary as desired (three telescoping portions are shown in the illustrated embodiment), but in one embodiment the locating device 68 includes at least two telescoping portions.

FIGS. 19 and 20 illustrate another embodiment of a spring-biased pin 76 that is collapsible upon itself and into the recess 40. The pin 76 includes a first cup 78 positioned at one axial end of the spring 80 and is telescopingly receivable in a second cup 82, at the other axial end thereof, when the pin 76 is collapsed, as shown in FIG. 20.

The embodiments described above show a pin arrangement in which a pin is positioned on the tensioner 12, and received in a recess 40 positioned in the anchor body 30. However, if desired, this configuration can be reversed. For example, with reference to FIG. 21, the pin 50 is carried on the anchor body 30, and the recess 40 is carried on the tensioner 12. In the embodiment shown in FIG. 21, the spring 52 has a cap 84 carried at the end thereof. Of course, any of the various embodiment described above can be reverse mounted in this manner.

FIGS. 22 and 23 illustrate another embodiment in which the existing pin stub 38 includes a fixed length extension 70 coupled thereto. In the illustrated embodiment the extension 70 is threadably coupled to the pin stub 38, and does not have an adjustable effective length. The extension 70 could be releasably or permanently coupled to the pin stub 38 by other devices, means or mechanisms, including via a press fit. Alternately, the extra-length pin 72 could be formed as a single, unitary piece of material with the base 20.

The resultant fixed-length pin 72 has extra length to ensure that the extension 70 is positioned in the recess 40, even after only a few turns of the threaded fastener 32. The extension 70 could be made of various materials, including steel, aluminum or filled nylon. The recess 40, in this case, includes sufficient depth to receive the pin therein when the fastener 32 is fully tightened down. The embodiment offers a relatively simple and inexpensive solution to provide sufficient alignment.

In this manner the adjustable length locating pin/device, and/or extra length pin, helps to ensure ease of alignment of the tensioner 12 during assembly, thereby avoiding issues with downstream manufacturing and/or mis-assembly. The pin/tensioner provides relatively inexpensive solutions that are easy to implement.

Having described the invention in detail and by reference to certain embodiments, it will be apparent that modifications and variations thereof are possible without departing from the scope of the invention.

What is claimed is:

1. A tensioning system comprising:
a body including a base and an engagement surface pivotally coupled to said base;
a biasing mechanism operatively coupled to said engagement surface to bias said engagement surface relative to said base; and
a locating device coupled to said body, said locating device being configured to rotationally position said tensioning system, wherein said locating device has an adjustable effective length.

2. The system of claim 1 wherein said locating device includes a pin.

3. The system of claim 1 wherein said locating device is configured to reduce its effective length when said locating device in inserted into a recess having a length shorter than an effective length of said locating device prior to said insertion, and wherein said locating device is configured to return to its original effective length when said locating device is removed from said recess.

4. The system of claim 1 wherein said locating device is configured to reduce its effective length when said locating device in inserted into a recess having a length shorter than an effective length of said locating device prior to said insertion, and wherein said locating device is configured to remain at said shorter length when said locating device is removed from said recess.

5. The system of claim 1 wherein said locating device is configured to reduce its effective length but retain its actual length unchanged when said locating device in inserted into a recess having a length shorter than said an effective length of said locating device prior to said insertion.

6. The system of claim 1 wherein said locating device is configured to reduce its actual length when said locating device in inserted into a recess having a length shorter than an effective length of said locating device prior to said insertion.

7. The system of claim 1 wherein said body includes an arm, and wherein said engagement surface is coupled to said arm, said locating device further including a spring having an axis extending generally parallel to said axis about which said arm is pivotable.

8. The system of claim 7 wherein said locating device includes a cap positioned at a free end of said spring.

9. The system of claim 7 wherein said locating device includes a pin stub directly coupled to said body, and wherein said spring is coupled to said pin stub.

10. The system of claim 1 wherein said locating device includes at least two telescoping portions.

11. The system of claim 1 wherein said locating device is frictionally held in place in said body.

12. The system of claim 1 wherein said body includes an arm, and wherein said arm is pivotally coupled to said base and said engagement surface is fixedly coupled to said arm.

13. The system of claim 12 wherein said engagement surface is positioned at one end of said arm and said biasing mechanism is positioned at another end thereof.

14. The system of claim 12 wherein said arm is pivotable relative to said base about an axis, and wherein said locating device extends generally parallel to said axis.

15. The system of claim 12 wherein said arm is pivotable relative to said base about an axis, and wherein said locating device has an effective length that is adjustable in a direction generally parallel to said axis.

16. The system of claim 12 wherein said body includes a central opening configured to receive a fastener therethrough which defines or is coincident with an axis about which said arm is pivotable, and wherein said locating device is radially offset relative to said axis.

17. The system of claim 1 wherein said system further includes an anchor body, and wherein said body includes a central opening receiving a fastener therethrough which is attachably received in said anchor body.

18. The system of claim 17 wherein said locating device is fixedly coupled to said body and said body includes a recess which receives said locating device therein.

19. The system of claim 18 wherein said recess has a depth that is less than a maximum effective length of said locating device.

20. The system of claim 18 wherein said locating device has a maximum effective length that is greater than a distance between a bottom of a head of the fastener and a top of the body when the fastener is initially threaded into the anchor body.

21. The system of claim 18 wherein the locating device has a maximum effective length that is greater than a difference between the length of the fastener and a length of the central opening.

22. The system of claim 17 further comprising a power transmitting element in the form of an endless loop, and wherein said engagement surface engages said power transmitting element as biased by said biasing mechanism to apply force to said power transmitting element and induce tension therein.

23. The system of claim 1 wherein said engagement surface includes a generally cylindrical roller rotationally coupled to said arm, and wherein said biasing mechanism includes a spring.

24. A method for assembling a tensioning system comprising:
accessing a tensioner including a body having a base, an engagement surface pivotally coupled to said base, and a biasing mechanism operatively coupled to said engagement surface to bias said engagement surface relative to said base, wherein the tensioner includes a locating device or a recess for a locating device;
accessing an anchor base having the other one of a locating device or a recess;
positioning said tensioner such that said locating device is received in said recess to rotationally position said tensioner; and
moving said tensioner closer to said base to thereby reduce the effective length of said locating device.

25. A tensioning system comprising:
a tensioning device including a body having a base and an engagement surface pivotally coupled to said base, said body including an opening configured to receive a fastener therethrough, the tensioning device further including a biasing mechanism operatively coupled to said engagement surface to bias said engagement surface relative to said base;
an anchor body, and wherein said fastener is receivable through said opening and in said anchor body;
a locating device coupled to said body or said anchor body; and
a recess positioned on the other one of said body or said anchor body, said locating device being configured to fit into said recess to rotationally position said tensioning system, wherein said locating device has a length that is greater than a distance between a bottom of a head of the fastener and a top of the body when the fastener is initially threaded into the anchor body.

26. The system of claim 25 wherein the fastener is a threaded fastener that is passable through said opening and threadably coupleable to the anchor body to thereby couple said tensioning device to said anchor body.

27. The system of claim 25 wherein the locating device has a length that is greater than a difference between the length of the fastener and a length of the central opening.

28. The system of claim 25 wherein the locating device is a pin having a fixed length.

29. The system of claim 28 wherein the recess has a length at least as great as the length of the pin.

30. The system of claim 25 wherein the locating device has an adjustable effective length.

31. The system of claim 30 wherein said locating device is configured to reduce its effective length when said locating device in inserted into a recess having a length shorter than an effective length of said locating device prior to said insertion.

32. The system of claim 30 wherein said locating device includes a spring having an axis extending generally parallel to said axis about which said engagement surface is pivotable.

33. The system of claim 25 wherein said body includes an arm, and wherein said arm is pivotally coupled to said base and said engagement surface is fixedly coupled to said arm, and wherein said arm is pivotable relative to said base about an axis, and said locating device extends generally parallel to said axis.

34. The system of claim 25 further comprising a power transmitting element in the form of an endless loop, and wherein said engagement surface engages said power transmitting element as biased by said biasing mechanism to apply force to said power transmitting element and induce tension therein.

35. The system of claim 25 wherein said fastener is initially threaded into the anchor body when said fastener is threaded the minimum amount required for said fastener to be axially coupled to said anchor body.

36. The system of claim 25 wherein said top of the body is the top surface of said body engaged by said head of the fastener when the fastener is fully threaded into the anchor body to secure the tensioning device in place.

37. A tensioning system comprising:
a tensioning device including a body having a base and an engagement surface pivotally coupled to said base, said body including an opening configured to receive a fastener therethrough, the tensioning device further including a biasing mechanism operatively coupled to said engagement surface to bias said engagement surface relative to said base;
an anchor body, and wherein said fastener is receivable in said anchor body;
a locating device coupled to said body or said anchor body; and
a recess positioned on the other one of said body or said anchor body, said locating device being configured to fit into said recess to rotationally position said tensioning device, the locating device has a length that is greater than a difference between the length of the fastener and a length of the central opening.
